(19) United States
(12) Patent Application Publication
(10) Pub. No.: US 2026/0332351 A1
(43) Pub. Date: Oct. 22, 2026

(54) RESOURCE BUNDLING FOR CONTROL RESOURCE SETS (CORESETs)

(71) Applicant: Lenovo (United States) Inc., Morrisville, NC (US)

(72) Inventor: Hossein Bagheri, Urbana, IL (US)

(73) Assignee: Lenovo (United States) Inc., Morrisville, NC (US)

(21) Appl. No.: 19/464,190

(22) Filed: Jan. 29, 2026

(51) Int. Cl. H04L 5/00; H04W 72/1273

(52) U.S. Cl. CPC H04L 5/0053; H04W 72/1273

(57) ABSTRACT

Various aspects of the present disclosure relate to resource bundling for control resource sets (CORESETs). A UE receives, from an NE, an indication of a CORESET including resource blocks (RBs), symbols, and a set of sub-CORESETs. In some examples, each sub-CORESET includes the RBs and one or more of the symbols. Further, the set of sub-CORESETs includes a set of resource element group (REG) bundles. In some examples, each sub-CORESET includes a REG bundle of the set of REG bundles. The UE or NE maps a control channel element (CCE) to at least one REG bundle of a sub-CORESET and maps a candidate physical downlink control channel (PDCCH) to at least one CCE.

### TECHNICAL FIELD

The present disclosure relates to wireless communications, and more specifically to resource bundling for control resource sets (CORESETs).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The device (e.g., NE or UE), processors, and methods of the present disclosure each have several innovative aspects, no single of which is solely responsible for the desirable features disclosed herein.

A UE for wireless communication is described. The UE may be configured to, capable of, or operable to perform one or more operations as described herein. For example, the UE may be configured to, capable of, or operable to receive an indication of a CORESET including a set (e.g., a list, a group, or a table) of resource blocks (RBs), a set of symbols, and a set of sub-CORESETs, each sub-CORESET of the set of sub-CORESETs including the set of RBs and a respective subset of the set of symbols, where the set of sub-CORESETs includes a set of resource element group (REG) bundles, each sub-CORESET of the set of sub-CORESETs including at least one REG bundle of the set of REG bundles, map a control channel element (CCE) to one or more REG bundles of a sub-CORESET of the set of sub-CORESETs, and map a candidate physical downlink control channel (PDCCH) to one or more CCEs including the CCE.

A processor (e.g., a standalone processor chipset, or a component of the UE) for wireless communication is described. The processor may be configured to, capable of, or operable to perform one or more operations as described herein. For example, the processor may be configured to, capable of, or operable to receive an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, map a CCE to one or more REG bundles of a sub-CORESET of the set of sub-CORESETs, and map a candidate PDCCH to one or more CCEs including the CCE.

A method performed or performable by a UE for wireless communication is described. The method may include receiving an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, mapping a CCE to one or more REG bundles of a sub-CORESET of the set of sub-CORESETs, and mapping a candidate PDCCH to one or more CCEs including the CCE.

In some implementations, the UE, the processor, and the method may further be configured to, capable of, or operable to determine a pattern for demodulation reference signals (DMRSs) based at least in part on a quantity of symbols of a REG bundle of the set of REG bundles satisfying a threshold quantity of symbols, allocate one or more REs of the REG bundle for DMRSs according to the pattern, and perform channel estimation over the REG bundle using the one or more REs of the REG bundle.

In some implementations, the pattern is further determined based at least in part on a quantity of sub-CORESETs included in the set of sub-CORESETs and a quantity of symbols included in the set of symbols of the CORESET. In some implementations, the CORESET includes a CORESET 0.

In some implementations, the UE, the processor, and the method may further be configured to, capable of, or operable to receive a master information block (MIB) indicating a quantity of sub-CORESETs included in the set of sub-CORESETs. In some implementations, each sub-CORESET of the set of sub-CORESETs includes a same quantity of symbols.

In some implementations, a quantity of sub-CORESETs included in the set of sub-CORESETs is based at least in part on one or more of a quantity of symbols included in the set of symbols of the CORESET or a configuration for DMRSs.

In some implementations, a quantity of REGs included in each REG bundle of the set of REG bundles includes six REGs, or is based at least in part on a function of a quantity of symbols included in the set of symbols of the CORESET and a quantity of sub-CORESETs included in the set of sub-CORESETs.

In some implementations, the UE, the processor, and the method may further be configured to, capable of, or operable to index the set of REG bundles according to a time-first, frequency-second pattern per sub-CORESET of the set of sub-CORESETs or index the set of REG bundles according to a time-first, frequency-second pattern across all sub-CORESETs of the set of sub-CORESETs.

An NE (e.g., a base station) for wireless communication is described. The NE may be configured to, capable of, or operable to perform one or more operations as described herein. For example, the NE may be configured to, capable of, or operable to transmit an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, map a CCE to one or more REG bundles of a sub-CORESET of the set of sub-CORESETs, and map a candidate PDCCH to one or more CCEs including the CCE.

A processor (e.g., a standalone processor chipset, or a component of an NE) for wireless communication is described. The processor may be configured to, capable of, or operable to perform one or more operations as described herein. For example, the processor may be configured to, capable of, or operable to transmit an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, map a CCE to one or more REG bundles of a sub-CORESET of the set of sub-CORESETs, and map a candidate PDCCH to one or more CCEs including the CCE.

A method performed or performable by an NE (e.g., a base station) for wireless communication is described. The method may include transmitting an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, mapping a CCE to one or more REG bundles of a sub-CORESET of the set of sub-CORESETs, and mapping a candidate PDCCH to one or more CCEs including the CCE.

In some implementations, the NE, the processor, and the method may further be configured to, capable of, or operable to determine a pattern for DMRSs based at least in part on a quantity of symbols of a REG bundle of the set of REG bundles satisfying a threshold quantity of symbols and allocate one or more REs of the REG bundle for DMRSs according to the pattern.

In some implementations, the pattern is further determined based at least in part on a quantity of sub-CORESETs included in the set of sub-CORESETs and a quantity of symbols included in the set of symbols of the CORESET. In some implementations, the CORESET includes a CORESET 0.

In some implementations, the NE, the processor, and the method may further be configured to, capable of, or operable to transmit a MIB indicating a quantity of sub-CORESETs included in the set of sub-CORESETs. In some implementations, each sub-CORESET of the set of sub-CORESETs includes a same quantity of symbols.

In some implementations, a quantity of REGs included in each REG bundle of the set of REG bundles includes six REGs, or is based at least in part on a function of a quantity of symbols included in the set of symbols of the CORESET and a quantity of sub-CORESETs included in the set of sub-CORESETs.

In some implementations, the NE, the processor, and the method may further be configured to, capable of, or operable to index the set of REG bundles according to a time-first, frequency-second pattern per sub-CORESET of the set of sub-CORESETs or index the set of REG bundles according to a time-first, frequency-second pattern across all sub-CORESETs of the set of sub-CORESETs.

### BRIEF DESCRIPTION OF THE DRAWINGS

FIG. 1 illustrates an example of a wireless communications system in accordance with aspects of the present disclosure.

FIG. 2 illustrates an example of a wireless communications system in accordance with aspects of the present disclosure.

FIG. 3 illustrates an example of a resource bundling scheme in accordance with aspects of the present disclosure.

FIG. 4 illustrates an example of a resource bundling scheme in accordance with aspects of the present disclosure.

FIG. 5 illustrates an example of a resource bundling scheme in accordance with aspects of the present disclosure.

FIG. 6 illustrates an example of a process flow in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of an NE in accordance with aspects of the present disclosure.

FIG. 10 illustrates an example of a flowchart of a method performed by a UE in accordance with aspects of the present disclosure.

FIG. 11 illustrates an example of a flowchart of a method performed by an NE in accordance with aspects of the present disclosure.

### DETAILED DESCRIPTION

In some wireless communication systems, an NE may configure a UE with a CORESET that the UE may use to monitor for PDCCH candidates. A CORESET may include a set of RBs and a set of symbols (e.g., three symbols). The UE and the NE may perform (e.g., apply) REG bundling within the CORESET. Particularly, adjacent REGs within the CORESETs may be grouped to form REG bundles. The quantity of REGs included in each REG bundle may be equal to a quantity of symbols of the CORESET or may be alternatively fixed at six REGs. Further, the UE and the NE may index the REG bundles in the CORESET according to a time-first, frequency-second pattern (e.g., ordering), and map one or more of the REG bundles to a CCE. In bandwidth-limited scenarios, the NE may configure the UE with an extended CORESET (e.g., a CORESET that includes more than three symbols). Similar REG bundling techniques may be applied by the NE and the UE to the extended CORESET. However, applying such REG bundling techniques to the extended CORESET may reduce the achievable frequency diversity for PDCCH candidates at lower aggregation levels. For example, if an aggregation level for a candidate PDCCH is equal to one, the corresponding CCE may be mapped to only one REG bundle, which, in the case of the extended CORESET spanning six symbols and using a REG bundle size of six, may correspond to only a single RB.

The techniques described herein provide a definition of REG bundles for extended CORESETs. In some examples, an NE may transmit, to a UE, an indication of a CORESET, such as an extended CORESET. The CORESET may include a set of RBs and a set of symbols. Additionally, the CORESET may include (e.g., be partitioned into) a set of sub-CORESETs, where each sub-CORESET includes the same set of RBs and a respective subset of the set of symbols of the CORESET. The UE and the NE may perform REG bundling across the set of sub-CORESETs. That is, the UE and the NE may identify a set of REG bundles in the set of sub-CORESETs. In some examples, each sub-CORESET may include at least one REG bundle from the set of REG bundles. Further, the NE and the UE may map a CCE to the one or more REG bundles within a sub-CORESET, and may map a PDCCH candidate to one or more CCEs including the CCE. By defining REG bundles at the sub-CORESET level, the mapping of a CCE for a PDCCH candidate with an aggregation level of one may span (e.g., mapped to) more than one RB of the total CORESET. As such, even for aggregation level one, frequency diversity across RBs may be improved compared to conventional extended CORESET bundling techniques.

It should be understood that various terms may be used interchangeably with “communicating,” such as “signaling,” “transmitting,” “receiving,” “outputting,” “forwarding,” “relaying,” “retrieving,” “obtaining,” and so forth.

By performing the techniques described, the wireless communications system provides flexible control of a REG bundle size for REG bundling of a CORESET. This flexible control of REG bundle size may allow the NE and the UE to achieve better frequency diversity when compared to other techniques.

Aspects of the present disclosure are described in the context of a wireless communications system. Additional aspects of the present disclosure are described in the context of component diagrams, process flows, method flows, etc. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

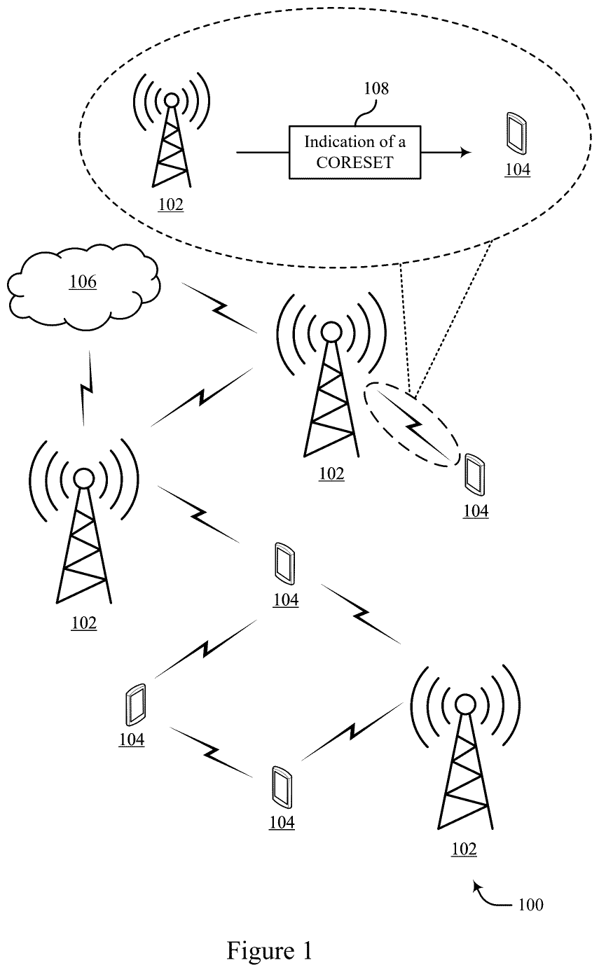

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHZ), FR4 (52.6 GHZ-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The NE 102 may configure the UE 104 with a CORESET which may be defined as a set of resources that the UE 104 may utilize to receive downlink control information (DCI) from the NE 102. The CORESET may span a set of frequency resources (e.g., a set of RBs) and a set of time resources (e.g., a set of symbols). The NE 102 and the UE 104 may map the DCI to the CORESET using a one or more techniques. As initial step, the NE 102 and the UE 104 may group REs of the CORESET into different REGs. Following this, the NE 102 and the UE 104 may then group the REGs into different REG bundles. A REG bundle may be described as a set of adjacent REGs that span one RB and one symbol period. In some examples, a same precoder may be applied to the set of adjacent REGs within the REG bundle.

In some examples, the NE 102 and the UE 104 may index the REG bundles. For example, the NE 102 and the UE 104 may index the REG bundles in increasing order according to a time-first, frequency-second pattern. In one example, REG bundle i may be defined as REGs {iL, iL+1, . . . , iL+L−1}, where L is a size of the REG bundle, i=0, 1, . . . ,

$${N}_{REG}^{CORESET} / L - 1 , and {N}_{REG}^{CORESET}$$

is a quantity of REGs in the CORESET. The NE 102 and the UE 104 may then map CCEs to the REG bundles. For example, the NE 102 and the UE 104 may map a single CCE to one or more consecutive REGs (e.g., six REGs). In some examples, the NE 102 and the UE 104 may perform the CCE-to-REG bundle mapping in a non-interleaved manner or an interleaved manner. In one example, CCE j includes REG bundles {f(6j/L), f(6j/L+1), . . . , f(6j/L+6/L−1)}, where f(⋅) is an interleaver. For a non-interleaved CCE-to-REG bundle mapping, L=6 and f(x)=x. For an interleaved CCE-to-REG bundle mapping, L∈{2, 6} for

$${N}_{symbol}^{CORESET} = 1 and L ∈ \{ {N}_{symbol}^{CORESET} , 6 \}$$

for

$${N}_{symbol}^{CORESET} ∈ \{ 2 , 3 \} .$$

The interleaver may be defined by Equation 1, where x=cR+r, r=0, 1, . . . , R−1, c=0, 1, . . . , C−1,

$$C = {N}_{REG}^{CORESET} / ( LR ) ,$$

### and R∈{2, 3, 6}.

$$f ( x ) = ( rC + c + {n}_{shift} ) mod ( {N}_{REG}^{CORESET} / L ) \qquad ( 1 )$$

As recited above, the UE 104 may receive a configuration for the CORESET from the NE 102. The configuration may include a ControlResourceSet information element (IE). For the CORESET configured by the ControlResourceSet IE,

$${N}_{RB}^{CORESET}$$

is given by a high-layer parameter frequencyDomainResources,

$${N}_{symbol}^{CORESET}$$

is given by a higher-layer parameter duration, the non-interleaved or interleaved CCE-to-REG bundle mapping is given by cce-REG-Mapping-Type, L is given by a higher-layer parameter reg-BundleSize, R is given by a high-layer parameter interleaverSize, and n_{shift}∈{0, 1, . . . , 274} is given by a higher-layer parameter shiftIndex. In some examples, if a higher-layer parameter precoderGranularity equals same AsREGBundle, the UE 104 may assume a same precoder is used within a REG bundle. Alternatively, if the higher-layer parameter precoderGranularity equals allContiguousRBs, the UE 104 may assume a same precoder is used across all REGs within a set of contiguous RBs in the CORESET and the UE 104 may assume that no REs in the CORESET overlap with a synchronization signal block (SSB).

Upon mapping CCEs to REG bundles, the UE 104 and the NE 102 may map a candidate PDCCH to one or more of the CCEs. For example, the UE 104 and the NE 102 may determine CCE indices for the candidate PDCCH using Equation 2, where

$${m}_{s , {n}_{CI}}^{( L )}$$

is the candidate PDCCH, s is a search space associated with the CORESET, p is the CORESET, L is an aggregation level corresponding to the candidate PDCCH,

$${n}_{s , f}^{μ}$$

is a slot of the search space, n_{CI} is a carrier indicator field (e.g., a carrier indicator field for a serving cell on which the candidate PDCCH is monitored or a nCI-Value associated with a set of serving cells MC-DCI-Setof Cells), N_{CCE,p} is a quantity of CCEs in the CORESET, and

$${M}_{s , {n}_{CI}}^{( L )}$$

is a quantity or candidate PDCCHs the UE 104 is configured to monitor for the aggregation level of the search space for the serving cell corresponding to carrier indicator field. In some examples, for any CSS,

$${Y}_{p , {n}_{s , f}^{μ}} = 0 and {M}_{s , max}^{( L )} = {M}_{s , 0}^{( L )} .$$

### Alternatively, for a USS,

$${Y}_{p , {n}_{s , f}^{μ}} = ( {A}_{p} \cdot {Y}_{p , {n}_{s , f}^{μ} - 1} ) mod D ,$$

where Y_{p,-1}=n_{RNTI}≠0, Aₚ=39827 for pmod3=0, Aₚ=39829 for pmod3=1, Aₚ=39839 for pmod3=2, D=65537 and

$${M}_{s , max}^{( L )}$$

is the maximum of

$${M}_{s , {n}_{CI}}^{( L )}$$

over all configured n_{CI} values for the aggregation level of the search space.

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ + 1 \qquad ( 2 )$$

In some examples, the UE 104 may be in a radio resource control (RRC) disconnected state. In such scenario, the UE 104 may receive a MIB from the NE 102 that includes a PDCCH-Config parameter defining a CORESET 0. Using the MIB, the UE 104 may determine two tables based on frequency range and subcarrier spacing (SCS). For example, the UE 104 may determine a first table using a minimum BW and the SCS and identify a row of the first table that provides the CORESET 0 configuration. The UE 104 may identify the row of the first table based on bits (e.g., 4-MSB bits) included in the PDCCH-Config parameter. The CORESET 0 configuration may include a quantity of RBs and a quantity of symbols for the CORESET 0, as well as an offset with respect to a reference RB such that the UE 104 may determine a frequency location of the CORESET 0.

The UE 104 may also determine a second table based on a row index of the row of the first table and SCS and identify a row of the second table that provides a search space set configuration for the CORESET 0. The UE 104 may identify the row of the second table based on bits (e.g., 4-LSB bits) included in the PDCCH-Config parameter. The second table may include multiple fields per row such as an ‘O’ field, a quantity of search space sets per slot field, an ‘M’ field, and a first symbol index in the slot field. CORESET 0 may be transmitted in even frames when [(O·2μ+└i·M┘)/Nₛₗₒₜ^{frame,μ}] mod 2=0 and in odd frames when [(O·2μ+└i·M┘)/Nₛₗₒₜ^{frame,μ}] mod 2=1, where O is a slot offset, i is a candidate SS/PBCH block index, M is a scaling factor, Nₛₗₒₜ^{frame,μ} is a quantity of slots in a radio frame for SCS configuration for a numerology index, and μ is the numerology index (related to SCS). The UE 104 may monitor PDCCH in a slot given by: n₀=(O·2^{μ}+└i·M┘) mod Nₛₗₒₜ^{frame,μ}. The UE 104 may monitor two consecutive slots starting from the slot (e.g., n₀ and n₀+1). In some examples, for CORESET 0, the UE 104 may assume an interleaved CCE-to-REG bundle mapping, a REG bundle of size 6, and an interleaver of size two.

In some scenarios, the NE 102 may configure the UE 104 with an extended CORESET. For example, the NE 102 may configure the UE 104 with a CORESET that spans more than a three symbols (e.g., six symbols or twelve symbols). The extended CORESET may be advantageous in bandwidth limited scenarios. For example, extended CORESETs may be beneficial in an EE processing state (due to a 5 MHz limitation), in IoT situations when the CORESET is rarely monitored (e.g., for firmware update), or for CORESET 0 (for SIB1). However, techniques for control resource bundling of the extended CORESET are not yet defined. Thus, the descriptions herein provide different techniques for control resource bundling of the extended CORESET. The techniques described herein may also apply to other types of control resource sets. For example, the techniques described herein may also apply to enhanced PDCCHs (ePDCCHs), where the ePDCCH duration includes a whole subframe and each enhanced CCE (eCCE) includes sixteen enhanced REGs (eREGs).

According to implementations, one or more of the NEs 102 and the UEs 104 are operable to implement various aspects of the techniques described with reference to the present disclosure. For example, the UE 104 receive an indication of a CORESET 108 including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, maps a CCE to one or more REG bundles of a sub-CORESET of the set of sub-CORESETs, and maps a candidate PDCCH to one or more CCEs including the CCE. An NE 102 (e.g., a base station, gNB) transmit an indication of a CORESET 108 including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, maps a CCE to one or more REG bundles of a sub-CORESET of the set of sub-CORESETs, and maps a candidate PDCCH to one or more CCEs including the CCE.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

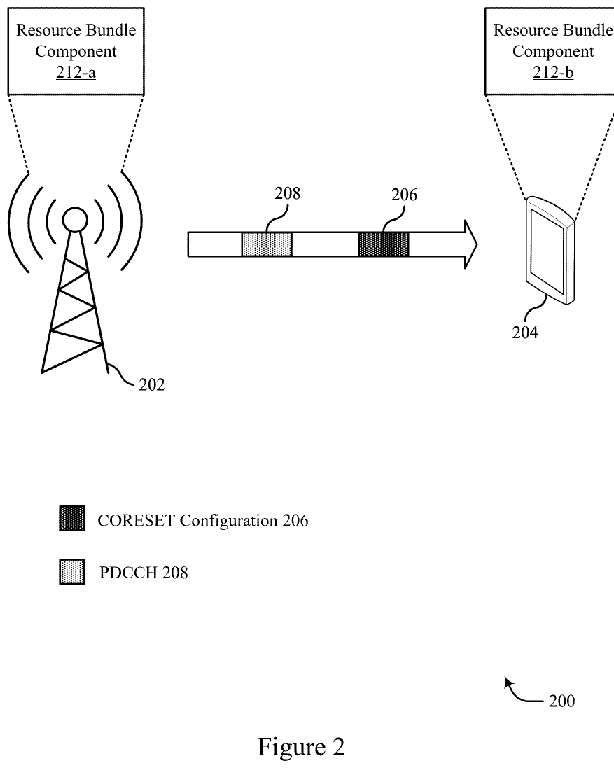

FIG. 2 illustrates an example of a wireless communications system 200 in accordance with aspects of the present disclosure. In some examples, the wireless communications system 200 may implement aspects of the wireless communications system 100. For example, an NE 202 and a UE 204 may be examples of the NE 102 and the UE 104 as described with reference to FIG. 1, respectively.

In some examples, the NE 202 may transmit a CORESET configuration 206 to the UE 204. The CORESET configuration 206 may include an indication of a CORESET. Specifically, the CORESET configuration 206 may include an indication of a set of RBs and a set of symbols that are included in the CORESET. In some examples, the CORESET may be an extended CORESET (or long CORESET). That is, the set of symbols included in the CORESET may include more than three symbols (e.g., six symbols or twelve symbols).

Upon communication of the CORESET configuration 206, the NE 202 and the UE 204 may perform various operations on the CORESET. For example, the NE 202 and the UE 204 may identify a set of REGs included in the CORESET. In some examples, each REG of the set of REGs may include a respective set of consecutive REs and each REG may span one RB in the frequency domain and one symbol in the time domain. Further, the NE 202 and the UE 204 may perform REG bundling on the CORESET. REG bundling may include grouping the set of REGs of the CORESET into one or more REG bundles. The NE 202 and the UE 204 may perform REG bundling according to one or more different techniques. In some examples, the UE 204 may include a resource bundle component 212-b that is configured to perform the one or more different REG bundling techniques described herein. Similarly, the NE 202 may include a resource bundle component 212-a that is configured to perform the one or more different REG bundling techniques described herein.

According to the first technique, the UE 204 and the NE 202 may perform REG bundling based on a predefined REG bundle size (or L). The predefined REG bundle size may define a quantity of REGs included in each REG bundle. In some examples, the predefined REG bundle size may be based on the quantity of symbols (or K) included in the set of symbols of the CORESET. For example, if the quantity of symbols included in the set of symbols of the CORESET is equal to six, the UE 204 and the NE 202 may determine that the predefined REG bundle size is equal to six. In another example, if the quantity of symbols included in the set of symbols of the CORESET is equal to or larger than six, the UE 204 and the NE 202 may determine that the predefined REG bundle size is equal to six.

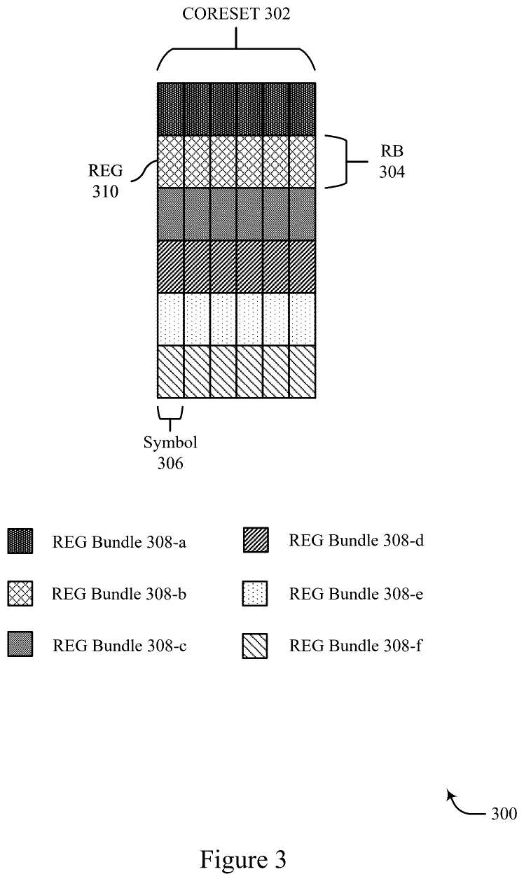

Upon determining the REG bundle size, the UE 204 and the NE 202 may bundle the REGs of the CORESETs in accordance with the predefined REG bundle size. For example, the UE 204 and the NE 202 may determine a first REG bundle that includes REGs corresponding to a first RB and six symbols of the CORESET, a second REG bundle that include REGs corresponding to a second RB and six symbols of the CORESET, and so on. Further, the UE 204 and the NE 202 may index the REG bundles in a time-first, frequency-second manner. That is, the UE 204 may assign a first index to the REG bundle corresponding to the highest frequency RB of the CORESET, a second index to the REG bundle corresponding to a second highest frequency RB of the CORESET, and so on. In some examples, the predefined REG bundle size may not be equal to the quantity of symbols included in the set of symbols of the CORESET. For example, if the CORESET includes six symbols, the predefined REG bundle size may be equal to one symbol, two symbols, three symbols, or any other quantity of symbols less than six symbols. In another example, if the CORESET includes twelve symbols, the predefined REG bundle size may be equal to one symbol, two symbols, three symbols, four symbols, or six symbols. Additional details are described with reference to FIG. 3.

According to a second technique, the UE 204 and the NE 202 may perform REG bundling based on a predefined rule associated with the REG bundle size. The predefined rule may indicate the REG bundle size to use for REG bundling in different scenarios. In one example, the predefined rule may indicate that the REG bundle size (or L) is equal to a factor of the quantity of symbols included in the set of symbols of the CORESET if the quantity of symbols included in the set of symbols of the CORESET are greater than or equal to a threshold (or T). For example, if the quantity of symbols included in the set of symbols of the CORESET is equal to six and the threshold is equal to six, the UE 204 and the NE 202 may determine that the REG bundle size is equal to three (or K/2) according to the predefined rule. In another example, if the quantity of symbols included in the set of symbols of the CORESET is equal to eight and the threshold is equal to six, the UE 204 and the NE 202 may determine that the REG bundle size is equal to one of two (or K/4) or four (or K/2) according to the predefined rule. Thus, the REG bundle size may be a dynamic value that changes according to different scenarios.

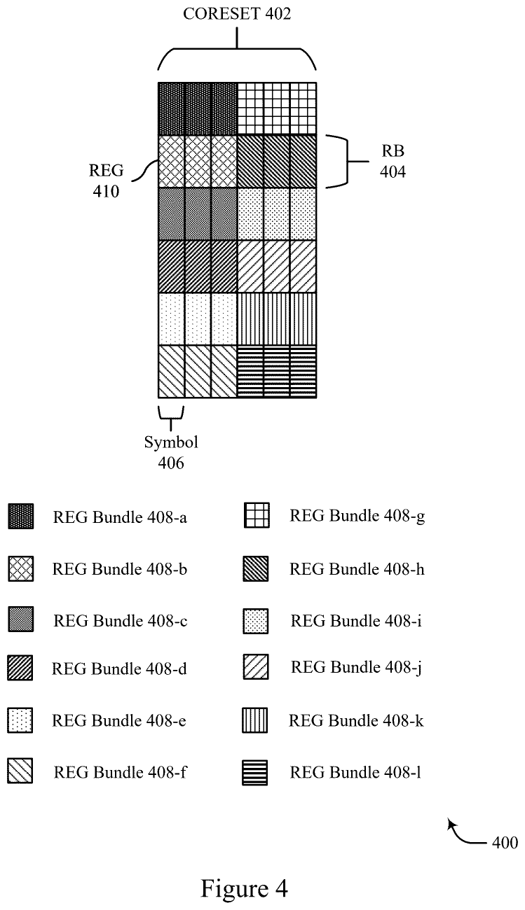

Upon determining the REG bundle size, the UE 204 and the NE 202 may bundle the REGs of the CORESETs in accordance with the REG bundle size. For example, the UE 204 and the NE 202 may determine a first REG bundle that includes REGs corresponding to a first RB and the first three symbols of the CORESET, a second REG bundle that include REGs corresponding to the first RB and the second three symbols of the CORESET, a third REG bundle that includes REGs corresponding to a second RB and the first three symbols of the CORESET, and so on. Further, the UE 204 and the NE 202 may index the REG bundles in a time-first, frequency-second manner. That is, the UE 204 may assign a first index to a REG bundle corresponding to the highest frequency RB and the first three symbols of the CORESET, a second index to a REG bundle corresponding to the highest frequency RB and the second three symbols of the CORESET, a third index to the REG bundle corresponding to a second highest frequency RB and the first three symbols of the CORESET, and so on. In some examples, the UE 204 and the NE 202 may utilize a different manner of REG bundle indexing (e.g., different than the time-first, frequency-second manner). Additional details are described with reference to FIG. 4.

According to a third technique, the UE 204 and the NE 202 may perform CORESET splitting. That is, the UE 204 and the NE 202 may split the CORESET into a set of sub-CORESETs. In some examples, each sub-CORESET may include the set of RBs of the CORESET and a respective subset of the set of symbols of the CORESET. The respective subsets of symbols may include one or more consecutive symbols. In some examples, the quantity of sub-CORESETs included in the set of sub-CORESETs (or N) may be based on the quantity of symbols included in the set of symbols of the CORESET. For example, the quantity of sub-CORESETs included in the set of sub-CORESETs may be equal to a factor of the quantity of symbols included in the set of symbols of the CORESET. As an example, if the quantity of symbols included in the set of symbols of the CORESET is equal to six, the quantity of sub-CORESETs included in the set of sub-CORESETs may be equal to two (or K/3). In such example, the sub-CORESETs included in the set of sub-CORESETs may include a first sub-CORESET that includes the set of RBs and the first three symbols of the CORESET and a second sub-CORESET that includes the set of RBs and the second three symbols of the CORESET. In some examples, the UE 204 and the NE 202 may perform CORESET splitting only if the quantity of symbols included in the set of symbols of the CORESET is greater than or equal to a threshold (e.g., three symbols). In some examples, the quantity of sub-CORESETs included in the set of sub-CORESETs is included in the CORESET configuration 206 or other configuration signaling (e.g., MIB for CORESET 0 or RRC signaling).

The UE 204 and the NE 202 may then perform REG bundling based on the set of sub-CORESETs. In one example, the UE 204 and the NE 202 may determine that the REG bundle size is a function of the quantity of the symbols included in the set of symbols of the CORESET and the quantity of sub-CORESETs included in the set of sub-CORESETs (e.g., K/N). For example, if the quantity of symbols included in the set of symbols of the CORESET is equal to six and the quantity of sub-CORESETs included in the set of sub-CORESETs is equal to two, the REG bundle size may be equal to 3 (or K/N). Alternatively, the REG bundle size may be equal to the quantity of symbols included in the set of symbols of the CORESET (e.g., six symbols). In some examples, the UE 204 and the NE 202 may bundle the REGs of the CORESET per sub-CORESET. For a REG bundle size of three, the UE 204 and the NE 202 may determine a first REG bundle includes REGs corresponding to a first RB of the CORESET and the three symbols of a first sub-CORESET, a second REG bundle that includes REGs corresponding to a second RB of the CORESET and the three symbols of the first sub-CORESET, a third REG bundle that includes REGs corresponding to the first RB of the CORESET and three symbols of the second sub-CORESET, and so on until all REGs of the CORESET are bundled together. That is, the UE 204 and the NE 202 may bundle the REGs of the CORESET such that each sub-CORESET may include at least one REG bundle.

The UE 204 and the NE 202 may then perform REG bundle indexing. Using a first scheme, the UE 204 and the NE 202 may perform the REG bundling indexing according in a time-first, frequency-second manner per sub-CORESET. For example, the UE 204 and the NE 202 may assign a first index to a REG bundle corresponding to a highest frequency RB of the first sub-CORESET, a second index to a REG bundle corresponding to a second highest frequency of the first sub-CORESET, and so on until all REG bundles of the first sub-CORESET are indexed. The UE 204 and the NE 202 may then move to the next consecutive sub-CORESET of the set of CORESETs (e.g., the second sub-CORESET) and continue indexing the remaining REG bundles in similar manner until all REG bundles of the CORESET are indexed. In another example, the UE 204 and the NE 202 may assign a first index to a REG bundle corresponding to a lowest frequency RB of the first sub-CORESET, a second index to a REG bundle corresponding to a second lowest frequency of the first sub-CORESET, and so on until all REG bundles of the first sub-CORESET are indexed. The UE 204 and the NE 202 may then move to the next consecutive sub-CORESET of the set of CORESETs (e.g., the second sub-CORESET) and continue indexing the remaining REG bundles in similar manner until all REG bundles of the CORESET are indexed.

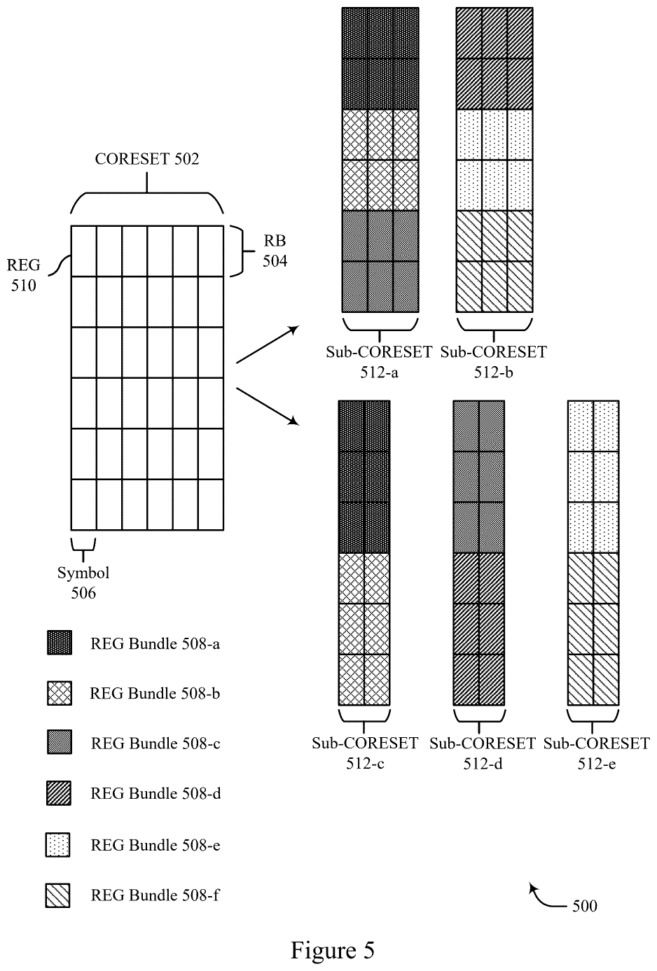

Using a second scheme, the UE 204 and the NE 202 may perform REG bundling indexing according to the time-first, frequency-second manner across all sub-CORESETs of the set of sub-CORESETs. For example, the UE 204 and the NE 202 may assign a first index to a REG bundle corresponding to a highest frequency RB of the first sub-CORESET and a second index to a REG bundle corresponding to the highest frequency of the second sub-CORESET. The UE 204 and the NE 202 may then move to the second highest frequency RB of the first sub-CORSET and continue indexing the remaining REG bundles in a similar fashion until all REG bundles of the CORESET are indexed. In another example, the UE 204 and the NE 202 may assign a first index to a REG bundle corresponding to a lowest frequency RB of the first sub-CORESET and a second index to a REG bundle corresponding to the lowest frequency of the second sub-CORESET. The UE 204 and the NE 202 may then move to the second lowest frequency RB of the first sub-CORSET and continue indexing the remaining REG bundles in a similar fashion until all REG bundles of the CORESET are indexed. Additional details are described with reference to FIG. 5.

Upon performing the REG bundling on the CORESET (e.g., in accordance to the first technique, the second technique, or the third technique), the UE 204 and the NE 202 may map CCEs to the REG bundles. For the first REG bundling technique and the second REG bundling technique, the UE 204 and the NE 202 may map CCEs to the REG bundles using similar operations as described in FIG. 1 with respect to interleaved CCE-to-REG bundle mapping or non-interleaved CCE-REG bundle mapping. For the third REG bundling technique, the UE 204 and the NE 202 may map the CCEs to the REG bundles in a non-interleaved manner using similar operations as described in FIG. 1 with respect to non-interleaved CCE-to-REG bundle mapping.

Different from FIG. 1, the UE 204 and the NE 202 may perform interleaved CCE-to-REG bundle mapping based on the set of sub-CORESETs for the third REG bundling technique. Using one scheme, the UE 204 and the NE 202 may apply an interleaving formula over all REG bundles of the CORESET such that a CCE may be mapped to REG bundles of multiple sub-CORESETs of the set of sub-CORESETs. In such example, L∈{2, 6} for

$${N}_{symbol}^{sub - CORESET} = 1 and L ∈ \{ {N}_{symbol}^{sub - CORESET} , 6 \}$$

for

$${N}_{symbol}^{sub - CORESET} ∈ \{ 2 , 3 \} .$$

The interleaver may be defined by Equation 1.

Using a second scheme, the UE 204 and the NE 202 may apply the interleaving formula over all REG bundles of a sub-CORESET such that a CCE may be mapped to one sub-CORESET and subsequent CCEs may be mapped to one or more sub-CORESETs. If smaller aggregation levels are selected, the UE 204 and the NE 202 may map a candidate PDCCH to only one sub-CORESET. Alternatively, if larger aggregation levels are selected, the UE 204 and the NE 202 may map a candidate PDCCH to multiple sub-CORESETs. For example, if the CORESET includes twenty-four RBs and six symbols with three sub-CORESETs, each sub-CORESET includes forty-eight REGs and eight REG bundles with a bundle size of six. In such case, if a large aggregation level is selected (e.g., AL16), two (e.g., consecutive) sub-CORESETs are used for the candidate PDCCH and if a small aggregation level is selected (e.g., AL2), one sub-CORESET is used for the candidate PDCCH.

Upon performing the CCE-to-REG bundle mapping, the UE 204 and the NE 202 may map a candidate PDCCH to one or more of the CCEs of the CORESET. In some examples, the UE 204 and the NE 202 map the candidate PDCCH to one or more of the CCEs using similar operations as described with reference to FIG. 1. The UE 204 may then monitor resources of the one or more CCEs that map to the candidate PDCCH and receive a PDCCH 208 from the NE 202 via the resources.

FIG. 3 illustrates an example of a resource bundling scheme 300 in accordance with aspects of the present disclosure. In some examples, the resource bundling scheme 300 may be implemented by the UE 104, the UE 204, the NE 102, or the NE 202 as described with reference to FIGS. 1 and 2.

In some examples, a UE may receive an indication of a CORESET 302 from the NE. As illustrated in FIG. 3, the CORESET 302 may include a set of RBs 304 and a set of symbols 306. Specifically, the CORESET 302 may include six RBs 304 and six symbols 306. However, it is understood that the techniques described herein may apply to a CORESET of any number of RBs and any number of symbols.

The UE and the NE may perform REG bundling on the CORESET 302. REG bundling may include grouping REGs 310 together to create respective REG bundles 308. The NE and the UE may be preconfigured with a REG bundle size. In some examples, the REG bundle size may be equal to six. In such case, the UE and the NE may bundle six REGs 310 together to form a single REG bundle 308. In some examples, the UE and the NE may bundle REGs 310 that include a same RB 304 together. For example, as shown in FIG. 3, the UE and the NE may identify a REG bundle 308-a, a REG bundle 308-b, a REG bundle 308-c, a REG bundle 308-d, a REG bundle 308-e, and a REG bundle 308-f. Each of the REG bundles 308 may include a respective set of six REGs 310 that correspond to a different RB 304 of the CORESET 302. The REG bundle size may include other values. For example, the REG bundle size may be equal to two or three. In some examples, the REG bundle size may be predefined at the UE and NE or configured by the NE.

Upon performing the REG bundling, the NE and the UE may perform REG bundle indexing. In some examples, the NE and the UE may perform the REG bundling indexing according to a time-first, frequency-second scheme. For example, the NE and the UE may assign a first index to the REG bundle 308-a, a second index to the REG bundle 308-b, a third index to the REG bundle 308-c, a fourth index to the REG bundle 308-d, a fifth index to the REG bundle 308-e, and a sixth index to the REG bundle 308-f.

FIG. 4 illustrates an example of a resource bundling scheme 400 in accordance with aspects of the present disclosure. In some examples, the resource bundling scheme 400 may be implemented by the UE 104, the UE 204, the NE 102, or the NE 202 as described with reference to FIGS. 1 and 2.

In some examples, a UE may receive an indication of a CORESET 402 from the NE. As illustrated in FIG. 4, the CORESET 402 may include a set of RBs 404 and a set of symbols 406. Specifically, the CORESET 402 may include six RBs 404 and six symbols 406. However, it is understood that the techniques described herein may apply to a CORESET of any number of RBs and any number of symbols.

The UE and the NE may perform REG bundling on the CORESET 402. REG bundling may include grouping REGs 410 together to create respective REG bundles 408. The NE and the UE may perform REG bundling according to a REG bundle size that is determined based on a predefined rule. In some examples, the predefined rule may indicate that the REG bundle size is equal to a factor of a quantity of symbols included in the set of symbols 406. For example, the REG bundle size may be equal to three because three is factor of six. In such case, the UE and the NE may bundle three REGs 410 together to form a single REG bundle 408. In some examples, the UE and the NE may bundle REGs that include a same RB 404 together. For example, as shown in FIG. 4, the UE and the NE may identify a REG bundle 408-a, a REG bundle 408-b, a REG bundle 408-c, a REG bundle 408-d, a REG bundle 408-e, a REG bundle 408-f, a REG bundle 408-g, a REG bundle 408-h, a REG bundle 408-i, a REG bundle 408-j, a REG bundle 408-k, and a REG bundle 408-l. Each of the REG bundles 408 may include a respective set of three REGs 410 that correspond to a respective RB 404 of the CORESET 402. In some examples, the REG bundle size may include other values. For example, the REG bundle size may alternatively be equal to one, two or six which are also factors of six.

Upon performing the REG bundling, the NE and the UE may perform REG bundle indexing. In some examples, the NE and the UE may perform the REG bundling indexing according to a time-first, frequency-second scheme. For example, the NE and the UE may assign a first index to the REG bundle 408-a, a second index to the REG bundle 408-g, a third index to the REG bundle 408-b, a fourth index to the REG bundle 408-h, a fifth index to the REG bundle 408-c, a sixth index to the REG bundle 408-i, a seventh index to REG bundle 408-d, an eighth index to REG bundle 408-j, a ninth index to REG bundle 408-e, a tenth index to REG bundle 408-k, an eleventh index to REG bundle 408-f, and a twelfth index to REG bundle 408-l.

FIG. 5 illustrates an example of a resource bundling scheme 500 in accordance with aspects of the present disclosure. In some examples, the resource bundling scheme 500 may be implemented by the UE 104, the UE 204, the NE 102, or the NE 202 as described with reference to FIGS. 1 and 2.

In some examples, a UE may receive an indication of a CORESET 502 from the NE. As illustrated in FIG. 5, the CORESET 502 may include a set of RBs 504 and a set of symbols 506. Specifically, the CORESET 502 may include six RBs 504 and six symbols 506. However, it is understood that the techniques described herein may apply to a CORESET of any number of RBs and any number of symbols.

In some examples, the NE and the UE may split the CORESET 502 into a set of sub-CORESETs 512. As shown in FIG. 5, the NE and the UE may split the CORESET 502 into different quantities of sub-CORESETs. In one example, the NE and the UE may split the CORESET 502 into two sub-CORESETs 512 (e.g., a sub-CORESET 512-a and a sub-CORESET 512-b). In another example, the NE and the UE may split the CORESET 502 into three sub-CORESETs 512 (e.g., a sub-CORESET 512-a, a sub-CORESET 512-b, and a sub-CORESET 512-c). In some examples, a configuration parameter may indicate how to split the CORESET 502 in a time domain. For example, the configuration parameter may indicate that each sub-CORESET 512 includes two symbols (e.g., the sub-CORESET 512-a, the sub-CORESET 512-b, and the sub-CORESET 512-c) or three symbols (e.g., the sub-CORESET 512-a and the sub-CORESET 512-b). The NE may include the configuration parameter in a same signal used to convey the configuration of the CORESET 502 or any other signal (e.g., MIB or RRC signal). In some examples, the UE and the NE may determine a quantity of sub-CORESETs 512 included in the set of sub-CORESET 512 based on a quantity of symbols included in the set of symbols 506. Further, each sub-CORESET 512 may include a same quantity of symbols.

The NE and UE may perform REG bundling on the CORESET 502 per sub-CORESET 512. REG bundling may include grouping REGs 510 together to create respective REG bundles 508. The NE and the UE may perform REG bundling according to a REG bundle size. In some examples, the REG bundle size may be equal to six. In other examples, the REG bundle size may be a function of the quantity of symbols included in the set of symbols 506 of the CORESET 502 (or K) and the quantity of sub-CORESETs 512 included in the set of sub-CORESETs 512 (or N). For example, the REG bundle size may be equal to K/N. Table 1 illustrates possible examples of K and N values.

TABLE 1

| K | N |
|---|---|
| 4 | 2 |
| 4 | 4 |
| 6 | 2 |
| 6 | 3 |
| 6 | 6 |
| 8 | 2 |
| 8 | 4 |
| 8 | 8 |
| 12 | 4 |
| 12 | 6 |
| 12 | 12 |

In the example of FIG. 5, the REG bundle size may be equal to 6. Thus, the UE and the NE may bundle six REGs 510 together to form a single REG bundle 508. For the three-symbol sub-CORESETs 512, the UE and the NE may identify a REG bundle 508-a, a REG bundle 508-b and a REG bundle 508-c in the sub-CORESET 512-a. Further, the NE and the UE may identify a REG bundle 508-d, a REG bundle 508-e and a REG bundle 508-f in the sub-CORESET 512-b. For the two-symbol sub-CORESETs 512, the UE and the NE may identify the REG bundle 508-a, the REG bundle 508-b in the sub-CORESET 512-c. Further, the UE and the NE may identify a REG bundle 508-c and a REG bundle 508-d in the sub-CORESET 512-d. Moreover, the UE and the NE may identify a REG bundle 508-e and a REG bundle 508-f in the sub-CORESET 512-e.

Upon performing the REG bundling, the NE and the UE may perform REG bundle indexing. In some examples, the NE and the UE may perform the REG bundling indexing according to a time-first, frequency-second scheme pattern per sub-CORESET 512. For the three-symbol sub-CORESETs 512 and the two-symbol sub-CORESETs 512, the NE and the UE may assign a first index to the REG bundle 508-a, a second index to the REG bundle 508-b, a third index to the REG bundle 508-c, a fourth index to the REG bundle 508-d, a fifth index to the REG bundle 508-e, and a sixth index to the REG bundle 508-f.

Alternatively, or additionally, the NE and the UE may perform REG bundling indexing according to a time-first, frequency-second pattern across all sub-CORESETs 512. For the three-symbol sub-CORESETs 512, the NE and the UE may assign a first index to REG bundle 508-a, a second index to REG bundle 508-d, a third index to REG bundle 508-b, a fourth index to REG bundle 508-e, a fifth index to REG bundle 508-c, and a sixth index to REG bundle 508-f. For the two-symbol sub-CORESETs 512, the NE and the UE may assign a first index to REG bundle 508-a, a second index to REG bundle 508-c, a third index to REG bundle 508-e, a fourth index to REG bundle 508-b, a fifth index to REG bundle 508-d, and a sixth index to REG bundle 508-f.

In addition to REG bundling, the NE and the UE may perform DMRS bundling. DMRS bundling may refer to having one DMRS channel estimate for all symbols within a bundle of symbols. If the quantity of symbols of the set of symbols 506 is greater than a threshold (e.g., greater than 3 symbols), the UE and the NE may perform the DMRS bundling. The NE may indicate a pattern for bundling the DMRS to the UE or the NE and UE may determine the patten for bundling the DMRS. Using the DMRS pattern, the UE and the NE determine which symbols 506 of REG bundles 508 include REs for DMRSs,

In one example, the pattern for DMRS bundling may indicate that every other symbol 506 includes REs for DMRSs. In another example, the pattern for DMRS bundling may indicate that only a quantity of beginning symbols 506 (e.g., two or three symbols) of a first sub-CORESET of the CORESET 502 (e.g., the sub-CORESET 512-a or the sub-CORESET 512-c) include REs for DMRSs. In yet another example, the pattern for DMRS bundling may be based on a duration of the sub-CORESETs 512. For example, for the two-symbols sub-CORESETs 512, the pattern for DMRS bundling may indicate that every symbol 506 of even sub-CORESETs 512 may include REs for DMRSs and every symbol of odd sub-CORESETs 512 may not include REs for DMRSs. As another example, the pattern for DMRS bundling may indicate that a first symbol of the sub-CORESET 512 may include REs for DMRSs and the remaining symbols 506 of the sub-CORESETs 512 may not include REs for DMRSs. When a non-interleaved CCE-to-REG bundle mapping is used, there is an even number of CCEs, and the CORESET 502 includes more than six symbols (e.g., twelve symbols), the NE and the UE may perform DMRS bundling across REG bundles 508 adjacent in time. The pattern for DMRS bundling can be repeated in time and the UE may assume one DMRS channel estimate for all symbols 506 of two time-adjacent REG bundles 508.

In some examples, the CORESET 502 may be an example of a CORESET 0. In such case, the UE and the NE may perform DMRS bundling based on a predefined rule. The predefined rule may indicate that no DMRS bundling is applied to the CORESET 0. Alternatively, the predefined rule may indicate to perform DMRS bundling according to a predefined pattern for DMRS bundling (e.g., one of the patterns for DMRS bundling as described above). In other examples, the pattern for DMRS may be indicated in one or more tables associated with the CORESET 0 (e.g., the first table or the second table as described with reference to FIG. 1).

As described in FIG. 1, the UE and the NE may utilize a first table for configuration the CORESET 0. The first table may include a set of rows that each define a respective set of configuration parameters for the CORESET 0. For example, each row of the first table may include an index, an SS/PBCH block and CORESET multiplexing pattern, a quantity of RBs, a quantity of symbols, and an RB offset value. To accommodate extended CORESETs 502 (e.g., CORESETs with a duration greater than 3 symbols), additional rows may be added to the first table. Such increase may result in additional bits in the MIB. In some examples, one or more configuration parameters may be removed from the first table (e.g., the RB offset value) such that a quantity of bits in the MIB are unchanged.

In another example, the NE and the UE may define a new table (e.g., a table different from the first table) for configuration of the CORESET 0. The new table may include a set of rows that each define a respective set of configuration parameters for the CORESET 0. For example, each row of the new table may include one or more of an index, an SS/PBCH block and CORESET multiplexing pattern, a quantity of RBs, a quantity of symbols, an RB offset value, or a quantity of sub-CORESETs 512 included in the CORESET 0 (or N). The new table may include a limited set of CORESET bandwidths for a set of CORESET durations (e.g., two, three, six, or twelve symbols). In another example, the new table may include a limited set of CORESET bandwidths for only an extended set of CORESET durations (e.g., six or twelve symbols). In another example, the new table may include a limited set of CORESET bandwidths for a set of CORESET durations (e.g., six or twelve symbols) and a limited set of sub-CORESET durations (e.g., two or three symbols). The UE may determine whether to utilize the first table or the new table for configuration of CORESET 0 based on an attribute of an SSB (e.g., SSB location in a frequency domain or a time domain) or based on a field included in the MIB. For example, the MIB may include a 1-bit field indicating for the UE to utilize either the first table or the new table for configuration of the CORESET 0. Table 2 illustrates an example of the new table.

TABLE 2

| | SS/PBCH block | | | | |
|---|---|---|---|---|---|
| | and CORESET | | Quantity | Quantity | RB |
| | multiplexing | Quantity | of | of sub- | Offset |
| Index | pattern | of RBs | Symbols | CORESETs | Value |
| 0 | 1 | 12 | 6 | 2 | 0 |
| 1 | 1 | 12 | 6 | 3 | 0 |
| 2 | 1 | 12 | 12 | 2 | 0 |
| 3 | 1 | 12 | 12 | 3 | 0 |
| 4 | 1 | 12 | 6 | 2 | 2 |
| 5 | 1 | 12 | 6 | 3 | 2 |
| 6 | 1 | 12 | 12 | 2 | 2 |
| 7 | 1 | 12 | 12 | 3 | 2 |
| 8 | 1 | 24 | 6 | 2 | 0 |
| 9 | 1 | 24 | 6 | 3 | 0 |
| 10 | 1 | 24 | 12 | 2 | 0 |
| 11 | 1 | 24 | 12 | 3 | 0 |
| 12 | 1 | 24 | 12 | 2 | 2 |
| 13 | 1 | 24 | 12 | 3 | 2 |
| 14 | 1 | 24 | 12 | 2 | 2 |
| 15 | 1 | 24 | 12 | 3 | 2 |

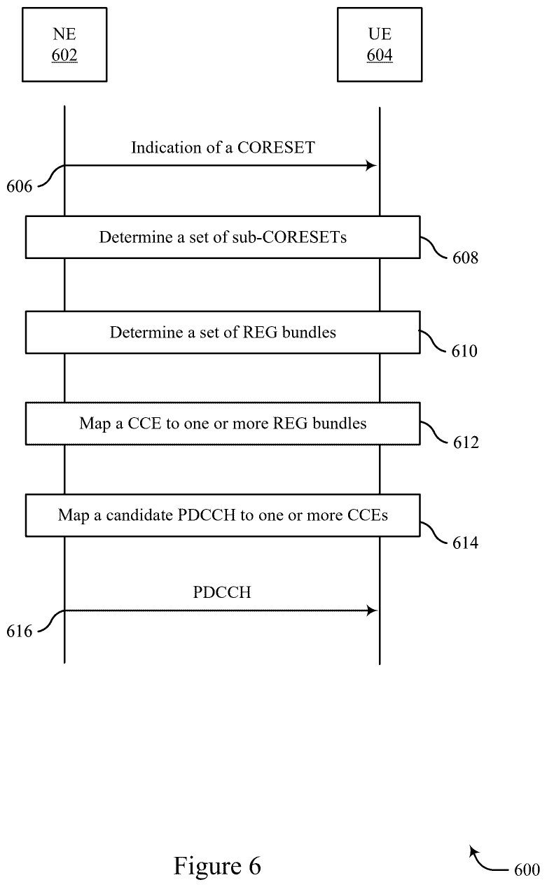

FIG. 6 illustrates an example of a process flow 600 in accordance with aspects of the present disclosure. In some examples, the process flow 600 may implement, or be implemented by, aspects of the wireless communications system 100 or the wireless communications system 200. For example, the process flow 600 may implement, or be implemented by, the UE 104, the UE 204, the NE 102, or the NE 202 as described with reference to FIGS. 1 and 2.

At 606, an NE 602 may transmit, to a UE 604, an indication of a CORESET that includes a set of RBs and a set of symbols.

At 608, the NE 602 and the UE 604 may determine a set of sub-CORESETs. In some examples, each sub-CORESET of the set of sub-CORESETs may include the set of RBs and a respective subset of the set of symbols. Further, each sub-CORESET of the set of sub-CORESETs may include a same quantity of symbols. A quantity of sub-CORESETs included in the set of sub-CORESETs may be based on one or more of a quantity of symbols included in the set of symbols of the CORESET or a configuration for DMRSs. In some examples, the CORESET may include a CORESET 0. In such case, the NE 602 may transmit, to the UE 604, a MIB indicating the quantity of sub-CORESETs included in set of sub-CORESETs.

At 610, the NE 602 and the UE 604 may determine a set of REG bundles in the set of sub-CORESETs. In some examples, each sub-CORESETs of the set of sub-CORESETs may include at least one REG bundle of the set of REG bundles. The NE 602 and the UE 604 may index the set of REG bundles using one of two techniques. Using a first techniques, the NE 602 and the UE 604 may index the set of REGs according to a time-first, frequency second pattern per sub-CORESET of the set of sub-CORESETs. Using a second technique, the NE 602 and the UE 604 may index the set of REGs according to a time-first, frequency second pattern across all sub-CORESETs of the set of sub-CORESETs.

In some examples, the NE 602 and the UE 604 may further determine a pattern for DMRSs based on a quantity of symbols included of a REG bundle of the set of REG bundles satisfying a threshold and allocate one or more REs of the REG bundle for DMRSs according to the pattern. The UE 604 may then perform channel estimation over the REG bundle using the one or more REs of the REG bundle. In some examples, the NE 602 and the UE 604 may also determine the pattern based on the quantity of sub-CORESETs included in the set of sub-CORESETs and the quantity of symbols in the set of symbols of the CORESET.

At 612, the NE 602 and the UE 604 may map a CCE to one or more REG bundles of the sub-CORESET of the set of sub-CORESETs. In some examples, the NE 602 and the UE 604 may map a CCE to one or more REG bundles of only one sub-CORESET of the set of sub-CORESETs.

At 614, the NE 602 and the UE 604 may map a candidate PDCCH to one or more CCEs including the CCE.

At 616, the NE 602 may transmit, to the UE 604, a PDCCH using the CORESET in accordance with the mappings determined at 612 and 614.

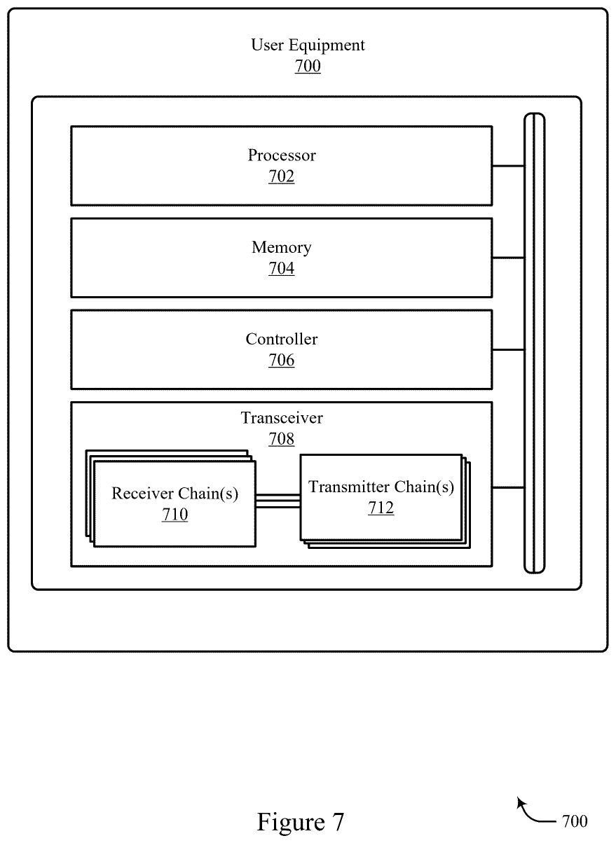

FIG. 7 illustrates an example of a UE 700 in accordance with aspects of the present disclosure. In some examples, the UE 700 may be an example of a UE as described with reference to FIGS. 1 through 6. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, mapping a CCE to one or more REG bundles of a sub-CORESET of the set of sub-CORESETs, and mapping a candidate PDCCH to one or more CCEs including the CCE.

Additionally, or alternatively, the UE 700 may support at least one memory (e.g., the memory 704) and at least one processor (e.g., the processor 702) coupled with the at least one memory and configured to cause the UE to receive an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, map a CCE to one or more REG bundles of a sub-CORESET of the set of sub-CORESETs, and map a candidate PDCCH to one or more CCEs including the CCE. In this manner, the UE 700 supports improved frequency diversity for extended CORESET durations by enabling CCE mapping within sub-CORESETs rather than across all symbols of the extended CORESET, which also enables opportunities for micro-sleep at the UE 700.

Additionally, the UE 700 may be configured to support any one or combination of the at least one processor configured to cause the UE 700 to determine a pattern for DMRSs based at least in part on a quantity of symbols of a REG bundle of the set of REG bundles satisfying a threshold quantity of symbols, allocate one or more REs of the REG bundle for DMRSs according to the pattern, and perform channel estimation over the REG bundle using the one or more REs of the REG bundle. This aspect enables efficient DMRS processing for extended CORESET durations by determining appropriate DMRS placement based on REG bundle size, improving channel estimation accuracy at the UE 700.

Additionally, the UE 700 may be configured to support any one or combination of the at least one processor configured to cause the UE 700 to receive a MIB indicating a quantity of sub-CORESETs included in the set of sub-CORESETs. This aspect enables the network to signal sub-CORESET configuration during initial access without requiring additional signaling overhead, improving system efficiency at the UE 700.

Additionally, the UE 700 may be configured to support any one or combination of the at least one processor configured to cause the UE 700 to index the set of REG bundles according to a time-first, frequency-second pattern per sub-CORESET of the set of sub-CORESETs or index the set of REG bundles according to a time-first, frequency-second pattern across all sub-CORESETs of the set of sub-CORESETs. This aspect enables flexible REG bundle indexing schemes that support both interleaved and non-interleaved CCE-to-REG mapping while maintaining compatibility with existing interleaver formulations, improving system flexibility at the UE 700.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

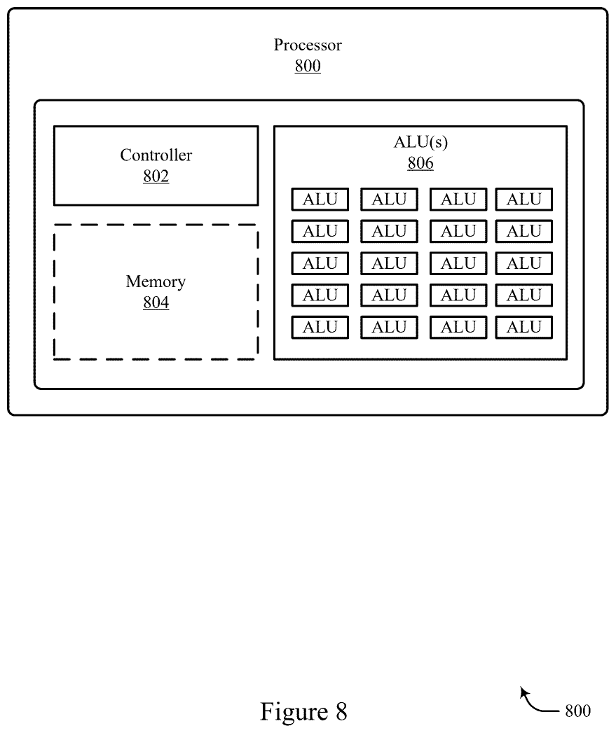

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, map a CCE to one or more REG bundles of a sub-CORESET of the set of sub-CORESETs, and map a candidate PDCCH to one or more CCEs including the CCE. In this manner, the processor 800 supports improved frequency diversity for extended CORESET durations by enabling CCE mapping within sub-CORESETs rather than across all symbols of the extended CORESET, which also enables opportunities for micro-sleep at the processor 800.

Additionally, the processor 800 may be configured to or operable to support any one or combination of determining a pattern for DMRSs based at least in part on a quantity of symbols of a REG bundle of the set of REG bundles satisfying a threshold quantity of symbols, allocating one or more REs of the REG bundle for DMRSs according to the pattern, and performing channel estimation over the REG bundle using the one or more REs of the REG bundle. This aspect enables efficient DMRS processing for extended CORESET durations by determining appropriate DMRS placement based on REG bundle size, improving channel estimation accuracy at the processor 800.

Additionally, the processor 800 may be configured to or operable to support any one or combination of receiving a MIB indicating a quantity of sub-CORESETs included in the set of sub-CORESETs. This aspect enables the network to signal sub-CORESET configuration during initial access without requiring additional signaling overhead, improving system efficiency at the processor 800.

Additionally, the processor 800 may be configured to or operable to support any one or combination of indexing the set of REG bundles according to a time-first, frequency-second pattern per sub-CORESET of the set of sub-CORESETs or indexing the set of REG bundles according to a time-first, frequency-second pattern across all sub-CORESETs of the set of sub-CORESETs. This aspect enables flexible REG bundle indexing schemes that support both interleaved and non-interleaved CCE-to-REG mapping while maintaining compatibility with existing interleaver formulations, improving system flexibility at the processor 800.

Moreover, the processor 800 may be configured to or operable to support at least one controller (e.g., the controller 802) coupled with at least one memory (e.g., the memory 804) and configured to cause the processor to transmit an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, map a CCE to one or more REG bundles of a sub-CORESET of the set of sub-CORESETs, and map a candidate PDCCH to one or more CCEs including the CCE. In this manner, the processor 800 supports improved frequency diversity for extended CORESET durations by enabling CCE mapping within sub-CORESETs rather than across all symbols of the extended CORESET, which also enables opportunities for micro-sleep at the processor 800.

Additionally, the processor 800 may be configured to or operable to support any one or combination of determining a pattern for DMRSs based at least in part on a quantity of symbols of a REG bundle of the set of REG bundles satisfying a threshold quantity of symbols and allocating one or more REs of the REG bundle for DMRSs according to the pattern. This aspect enables efficient DMRS processing for extended CORESET durations by determining appropriate DMRS placement based on REG bundle size, improving channel estimation accuracy at the processor 800.

Additionally, the processor 800 may be configured to or operable to support any one or combination of transmitting a MIB indicating a quantity of sub-CORESETs included in the set of sub-CORESETs. This aspect enables the network to signal sub-CORESET configuration during initial access without requiring additional signaling overhead, improving system efficiency at the processor 800.

Additionally, the processor 800 may be configured to or operable to support any one or combination of indexing the set of REG bundles according to a time-first, frequency-second pattern per sub-CORESET of the set of sub-CORESETs or indexing the set of REG bundles according to a time-first, frequency-second pattern per sub-CORESET of the set of sub-CORESETs. This aspect enables flexible REG bundle indexing schemes that support both interleaved and non-interleaved CCE-to-REG mapping while maintaining compatibility with existing interleaver formulations, improving system flexibility at the processor 800.

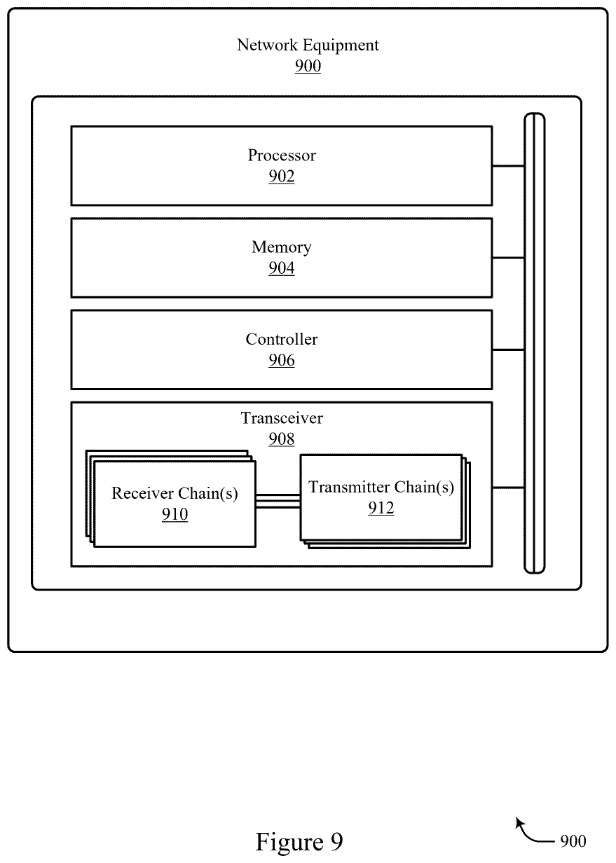

FIG. 9 illustrates an example of an NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, mapping a CCE to one or more REG bundles of a sub-CORESET of the set of sub-CORESETs, and mapping a candidate PDCCH to one or more CCEs including the CCE.

Additionally, or alternatively, the NE 900 may support at least one memory (e.g., the memory 904) and at least one processor (e.g., the processor 902) coupled with the at least one memory and configured to cause the NE to transmit an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles, map a CCE to one or more REG bundles of a sub-CORESET of the set of sub-CORESETs, and map a candidate PDCCH to one or more CCEs including the CCE. In this manner, the NE 900 supports improved frequency diversity for extended CORESET durations by enabling CCE mapping within sub-CORESETs rather than across all symbols of the extended CORESET, which also enables opportunities for micro-sleep at the UE.

Additionally, the NE 900 may be configured to support any one or combination of the at least one processor configured to cause the NE 900 to determine a pattern for DMRSs based at least in part on a quantity of symbols of a REG bundle of the set of REG bundles satisfying a threshold quantity of symbols and allocate one or more REs of the REG bundle for DMRSs according to the pattern. This aspect enables efficient DMRS processing for extended CORESET durations by determining appropriate DMRS placement based on REG bundle size, improving channel estimation accuracy at the NE 900.

Additionally, the NE 900 may be configured to support any one or combination of the at least one processor configured to cause the NE 900 to transmit a MIB indicating a quantity of sub-CORESETs included in the set of sub-CORESETs. This aspect enables the network to signal sub-CORESET configuration during initial access without requiring additional signaling overhead, improving system efficiency at the NE 900.

Additionally, the NE 900 may be configured to support any one or combination of the at least one processor configured to cause the NE 900 to index the set of REG bundles according to a time-first, frequency-second pattern per sub-CORESET of the set of sub-CORESETs or index the set of REG bundles according to a time-first, frequency-second pattern across all sub-CORESETs of the set of sub-CORESETs. This aspect enables flexible REG bundle indexing schemes that support both interleaved and non-interleaved CCE-to-REG mapping while maintaining compatibility with existing interleaver formulations, improving system flexibility at the NE 900.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

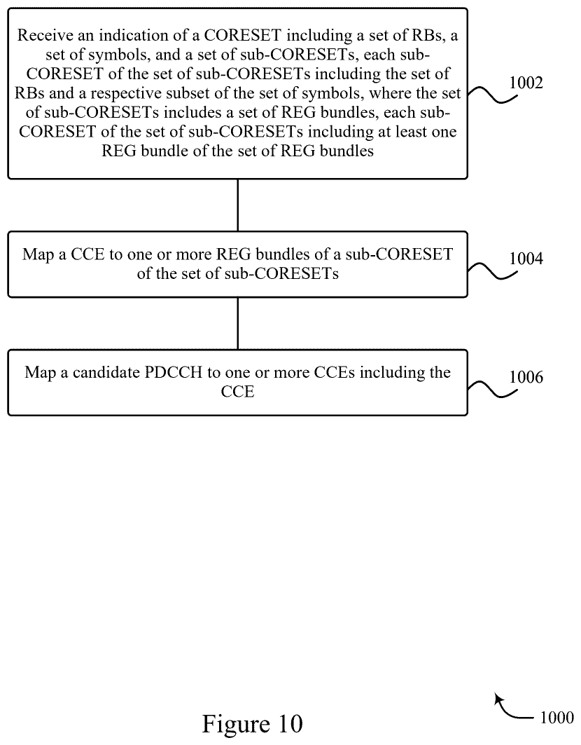

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles. The operations of 1002 may be performed in accordance with examples as described herein. In some implementations, aspects of the operations of 1002 may be performed by the UE 700 as described with reference to FIG. 7.

At 1004, the method may include mapping a CCE to one or more REG bundles of a sub-CORESET of the set of sub-CORESETs. The operations of 1004 may be performed in accordance with examples as described herein. In some implementations, aspects of the operations of 1004 may be performed by the UE 700 as described with reference to FIG. 7.

At 1006, the method may include mapping a candidate PDCCH to one or more CCEs including the CCE. The operations of 1006 may be performed in accordance with examples as described herein. In some implementations, aspects of the operations of 1006 may be performed the UE 700 as described with reference to FIG. 7.

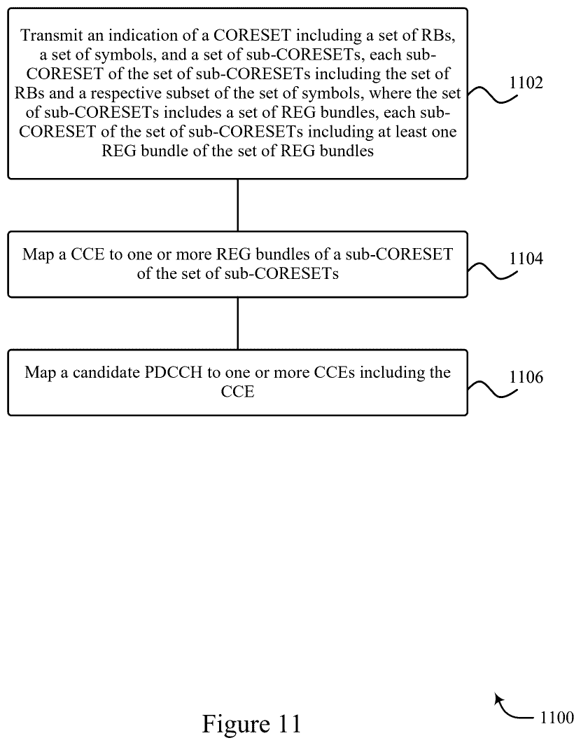

FIG. 11 illustrates a flowchart of a method 1100 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting an indication of a CORESET including a set of RBs, a set of symbols, and a set of sub-CORESETs, each sub-CORESET of the set of sub-CORESETs including the set of RBs and a respective subset of the set of symbols, where the set of sub-CORESETs includes a set of REG bundles, each sub-CORESET of the set of sub-CORESETs including at least one REG bundle of the set of REG bundles. The operations of 1102 may be performed in accordance with examples as described herein. In some implementations, aspects of the operations of 1102 may be performed by the NE 900 as described with reference to FIG. 9.

At 1104, the method may include mapping a CCE to one or more REG bundles of a sub-CORESET of the set of sub-CORESETs. The operations of 1104 may be performed in accordance with examples as described herein. In some implementations, aspects of the operations of 1104 may be performed by the NE 900 as described with reference to FIG. 9.

At 1106, the method may include mapping a candidate PDCCH to one or more CCEs including the CCE. The operations of 1106 may be performed in accordance with examples as described herein. In some implementations, aspects of the operations of 1106 may be performed by the NE 900 as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communications, comprising:
one or more memories; and
one or more processors coupled with the one or more memories and individually or collectively operable to cause the UE to:
receive a signal indicating a control resource set (CORESET) comprising a set of resource blocks (RBs), a set of symbols, and a plurality of sub-CORESETs, each sub-CORESET of the plurality of sub-CORESETs comprising the set of RBs and a respective subset of the set of symbols, wherein the plurality of sub-CORESETs comprises a plurality of resource element group (REG) bundles, each sub-CORESET of the plurality of sub-CORESETs comprising at least one REG bundle of the plurality of REG bundles;
map a control channel element (CCE) to one or more REG bundles of a sub-CORESET of the plurality of sub-CORESETs; and
map a candidate physical downlink control channel (PDCCH) to one or more CCEs comprising the CCE.

2. The UE of claim 1, wherein the one or more processors are further operable to cause the UE to:
determine a pattern for demodulation reference signals (DMRSs) based at least in part on a quantity of symbols of a REG bundle of the plurality of REG bundles satisfying a threshold quantity of symbols;
allocate one or more resource elements (REs) of the REG bundle for DMRSs according to the pattern; and
perform channel estimation over the REG bundle using the one or more REs of the REG bundle.

3. The UE of claim 2, wherein the pattern is further determined based at least in part on a quantity of sub-CORESETs comprised in the plurality of sub-CORESETs and a quantity of symbols comprised in the set of symbols of the CORESET.

4. The UE of claim 1, wherein the CORESET comprises a CORESET 0.

5. The UE of claim 4, wherein the one or more processors are further operable to cause the UE to:
receive a master information block (MIB) indicating a quantity of sub-CORESETs comprised in the plurality of sub-CORESETs.

6. The UE of claim 1, wherein each sub-CORESET of the plurality of sub-CORESETs comprises a same quantity of symbols.

7. The UE of claim 1, wherein a quantity of sub-CORESETs comprised in the plurality of sub-CORESETs is based at least in part on one or more of a quantity of symbols comprised in the set of symbols of the CORESET or a configuration for demodulation reference signals (DMRSs).

8. The UE of claim 1, wherein a quantity of REGs comprised in each REG bundle of the plurality of REG bundles comprises six REGs, or is based at least in part on a function of a quantity of symbols comprised in the set of symbols of the CORESET and a quantity of sub-CORESETs comprised in the plurality of sub-CORESETs.

9. The UE of claim 1, wherein the one or more processors are further operable to cause the UE to:
index the plurality of REG bundles according to a time-first, frequency-second pattern per sub-CORESET of the plurality of sub-CORESETs; or
index the plurality of REG bundles according to a time-first, frequency-second pattern across all sub-CORESETs of the plurality of sub-CORESETs.

10. A network equipment (NE) for wireless communications, comprising:
one or more memories; and
one or more processors coupled with the one or more memories and individually or collectively operable to cause the NE to:
transmit a signal indicating a control resource set (CORESET) comprising a set of resource blocks (RBs), a set of symbols, and a plurality of sub-CORESETs, each sub-CORESET of the plurality of sub-CORESETs comprising the set of RBs and a respective subset of the set of symbols, wherein the plurality of sub-CORESETs comprises a plurality of resource element group (REG) bundles, each sub-CORESET of the plurality of sub-CORESETs comprising at least one REG bundle of the plurality of REG bundles;
map a control channel element (CCE) to one or more REG bundles of a sub-CORESET of the plurality of sub-CORESETs; and
map a candidate physical downlink control channel (PDCCH) to one or more CCEs comprising the CCE.

11. The NE of claim 10, wherein the one or more processors are further operable to cause the NE to:
determine a pattern for demodulation reference signals (DMRSs) based at least in part on a quantity of symbols of a REG bundle of the plurality of REG bundles satisfying a threshold quantity of symbols; and
allocate one or more resource elements (REs) of the REG bundle for DMRSs according to the pattern.

12. The NE of claim 11, wherein the pattern is further determined based at least in part on a quantity of sub-CORESETs comprised in the plurality of sub-CORESETs and a quantity of symbols comprised in the set of symbols of the CORESET.

13. The NE of claim 10, wherein the CORESET comprises a CORESET 0.

14. The NE of claim 13, wherein the one or more processors are further operable to cause the NE to:
transmit a master information block (MIB) indicating a quantity of sub-CORESETs comprised in the plurality of sub-CORESETs.

15. The NE of claim 10, wherein each sub-CORESET of the plurality of sub-CORESETs comprises a same quantity of symbols.

16. The NE of claim 10, wherein a quantity of sub-CORESETs comprised in the plurality of sub-CORESETs is based at least in part on one or more of a quantity of symbols comprised in the set of symbols of the CORESET or a configuration for demodulation reference signals (DMRSs).

17. The NE of claim 10, wherein a quantity of REGs comprised in each REG bundle of the plurality of REG bundles comprises six REGs, or is based at least in part on a function of a quantity of symbols comprised in the set of symbols of the CORESET and a quantity of sub-CORESETs comprised in the plurality of sub-CORESETs.

18. The NE of claim 10, wherein the one or more processors are further operable to cause the NE to:
index the plurality of REG bundles according to a time-first, frequency-second pattern per sub-CORESET of the plurality of sub-CORESETs; or
index the plurality of REG bundles according to a time-first, frequency-second pattern across all sub-CORESETs of the plurality of sub-CORESETs.

19. A method performed by a user equipment (UE), the method comprising:
receiving a signal indicating a control resource set (CORESET) comprising a set of resource blocks (RBs), a set of symbols, and a plurality of sub-CORESETs, each sub-CORESET of the plurality of sub-CORESETs comprising the set of RBs and a respective subset of the set of symbols, wherein the plurality of sub-CORESETs comprises a plurality of resource element group (REG) bundles, each sub-CORESET of the plurality of sub-CORESETs comprising at least one REG bundle of the plurality of REG bundles;
mapping a control channel element (CCE) to one or more REG bundles of a sub-CORESET of the plurality of sub-CORESETs; and
mapping a candidate physical downlink control channel (PDCCH) to one or more CCEs comprising the CCE.

20. A method performed by a network equipment (NE), the method comprising:
transmitting a signal indicating a control resource set (CORESET) comprising a set of resource blocks (RBs), a set of symbols, and a plurality of sub-CORESETs, each sub-CORESET of the plurality of sub-CORESETs comprising the set of RBs and a respective subset of the set of symbols, wherein the plurality of sub-CORESETs comprises a plurality of resource element group (REG) bundles, each sub-CORESET of the plurality of sub-CORESETs comprising at least one REG bundle of the plurality of REG bundles;
mapping a control channel element (CCE) to one or more REG bundles of a sub-CORESET of the plurality of sub-CORESETs; and
mapping a candidate physical downlink control channel (PDCCH) to one or more CCEs comprising the CCE.
